(19) United States
(12) Patent Application Publication
(10) Pub. No.: US 2014/0087355 A1
(43) Pub. Date: Mar. 27, 2014

(54) GAMING PLATFORM FOR THE DEVELOPMENT AND EXECUTION OF CUSTOMIZED GAMES AND GAME COMPONENTS

(71) Applicant: GameMetrix Solutions, Inc., Salem, MA (US)

(72) Inventors: Bonnie Williams Henry, Salem, MA (US); Thomas R. Dusenberry, Salem, MA (US); Brent J. Nordquist, Coon Rapids, MN (US); Theodore Joseph Collins, III, Billerica, MA (US)

(73) Assignee: GameMetrix Solutions, Inc., Salem, MA (US)

(21) Appl. No.: 14/035,600

(22) Filed: Sep. 24, 2013

Related U.S. Application Data
(60) Provisional application No. 61/704,888, filed on Sep. 24, 2012.

(51) Int. Cl. G09B 7/00

(52) U.S. Cl. CPC G09B 7/00
USPC 434/362

(57) ABSTRACT

A computerized educational game includes multiple formats for questions on a variety of topics related to health, wellness and education and other topics. In one embodiment, questions and answers for the game are stored so that the individual questions can be downloaded in more than one format. For example, the questions and answers may be stored so that they can be answered as “fill in the blank” questions in which the user must supply an answer. The same question may be formatted as a multiple choice question, in which the user is required to select a correct answer from among a plurality of answers. The questions and answers may also be formatted for use in multiple game formats, e.g., a quiz game, a puzzle game, a choose-best-from-list game, a matching game, or a reverse quiz game in which an answer is supplied and the player guesses or selects the question.

### CROSS-REFERENCE TO RELATED APPLICATIONS

This application claims the benefit of the following United States Provisional Application, which is hereby incorporated by reference herein in its entirety: U.S. Provisional Application No. 61/704,888, entitled A GAMING PLATFORM FOR CUSTOMIZATION OF GAME PLAY AND GAME CONTENT, filed Sep. 24, 2012.

### BACKGROUND

1. Field

This disclosure is related to the development and customization of multimedia games and gaming content using an adaptable game development platform.

2. Description of the Related Art

Game development and integration of gaming content within existing presentation modalities, such as websites, may be hampered by high development costs and lengthy development periods that are required to write software code, beta test game modules, and create functional and appealing user interfaces. This high cost and lengthy development process may pose obstacles to creating and utilizing gaming applications in environments that cannot drive significant numbers of users and or revenues to a game application within a short period of time in order to recoup the initial investment required for development. This may be especially prohibitive for certain markets, such as education, that, while having a large pool of potential users of gaming content, typically do not have the resources necessary for game development. Therefore, a need exists for a gaming platform that may offer efficiencies over other methods of game development, based at least in part on the utilization of a gaming platform that includes streamlined integration into third-party systems, customization, the capacity to quickly introduce enhancements, and to assess and implement user feedback.

### SUMMARY

The present disclosure enables the development and operation of computer games that draw on shared components, such that games may be created or modified without the need for additional programming. The present disclosure provides a gaming platform and associated systems and methods that enable the creation, distribution, execution, and modification of computer games through the use of modular game components. These components may include (1) engines that provide functionality, (2) content files that include text, sounds, pictures, videos, data, and other information, and (3) other facilities that enable or facilitate game playing and related activities, such as reporting on top scores, providing feedback to players, enabling social interaction among players, and game account personalization. These components may be adapted for use in two or more games without requiring a developer to modify source code of the game components and may be remotely or locally stored. In embodiments where game components are remotely stored, they may be accessed by a game through the use of a software service. This gaming platform may enable the creation of multiple games that make use of shared components and may allow game creation, distribution, and modification without the need for computer programming. Such computer games may be played on computing devices. As used herein, the term “computing device” refers to a computer or a mobile device such as a tablet, smart phone, personal media player, or the like. Such computing devices may operate using one or more operating systems, including Windows, MacOS, Linux, Unix, iOS, Android, Chrome OS, Windows Mobile, Windows CE, Windows Phone OS, Blackberry OS, and the like.

In embodiments, games created using the gaming platform may be educational. In an example of these embodiments, health and health management education games may be created that teach players about such issues as diabetes treatment, smoking-cessation, and weight loss. In some of these embodiments, such games may involve a question and answer format. In an example of these embodiments, the gaming platform may be used to create and to play a health education quiz game in which a players are asked questions on one or more health or health management-related topics and in which playing the game is intended to improve the health of the player or one or more other individuals whose health care the player is in a position to influence. In other embodiments, games created using the gaming platform may be designed for entertainment purposes.

One embodiment is a method of creating and playing a computerized game. The method includes using at least one computing device to perform the following steps in any order: (1) selecting a game type (e.g. quiz game, puzzle game, a choose-best-from-list game, matching game, etc.), (2) selecting game functionality, (3) selecting and arranging existing game content or creating new game content, (4) accepting input from the player and providing feedback to the player during game play, and (5) providing additional feedback to the player after game play has ended, wherein the game content is adapted for use in at least two different games. In an example of this embodiment, game content may be comprised of questions on an educational topic, such that one or more computing devices may be used to arrange the questions, to prepare answers to the questions, to enable the player or players to input answers to the questions, to inform the player or players whether those answers are correct, and to provide each player with a score.

Another embodiment is a method of creating and playing a computerized game. The method includes using at least one computing device to perform the following steps in any order: (1) selecting a game type (e.g. quiz game, puzzle game, a choose-best-from-list game, matching game, etc.), (2) selecting game functionality, (3) selecting and arranging existing game content or creating new game content, (4) accepting input from the player and providing feedback to the player during game play, and (5) providing additional feedback to the player after game play has ended, wherein the question and the answers are adapted for use in at least two different game types. In an example of this embodiment, game content may be comprised of questions on an educational topic, such that one or more computing devices may be used to arrange the questions, to prepare answers to the questions, to enable the player or players to input answers to the questions, to inform the player or players whether those answers are correct, and to provide each player with a score.

Another embodiment is a system for computerized games. The system includes a content database accessible to at least one computing device, the content database comprising text, images, audio files, video files, and other information that may be used as part of one or more games. Such content database may group data stored into related sets, such that a set of data may be selected for inclusion in a given game. In examples of this embodiment involving a health quiz game, the content database may include questions and answers on a plurality of health and health management topics. In one such example, there may be a diabetes information data set and a smoking-cessation information data set. In this embodiment, there are also engines for various game types (e.g. a quiz game engine, a matching game engine, a puzzle game engine, etc.). These engines may share functional engines (e.g. an analytics engine, an alert engine), such that multiple game engines may access any given functional engine. The system also includes a gaming engine whose software components may be stored on a non-transitory memory of one or more computing devices, the gaming engine enabled to assemble and execute games from available components, including data sets and the engines for various game types. Continuing the example, there may be a health quiz game that uses the quiz engine and the diabetes information data set, where each game is designated as a certain game type and access appropriate functionality (e.g. a quiz game) and where each game access at least one data set (e.g. diabetes information). The system may also include a gaming portal for monitoring aspects of the gaming engine and the content database, an interface for a plurality of players for the game, the interface allowing the plurality of players access to the gaming engine and the application database, and a graphical user interface accessible to the plurality of players for the game, the graphical user interface downloadable onto local computing devices for the one or more players or accessible through one or more servers.

These and many more embodiments are within the scope of the present disclosure.

### BRIEF DESCRIPTION OF THE FIGURES

The disclosure and the following detailed description of certain embodiments thereof may be understood by reference to the following figures:

FIG. 1A illustrates a simplified embodiment of the gaming platform and related facilities.

FIG. 1B illustrates a second simplified embodiment of the gaming platform and related facilities.

FIG. 2 illustrates selected facilities within the gaming platform and example functionalities of the facilities.

FIG. 3 illustrates example embodiments of gaming platform content and components.

FIG. 4 depicts a simplified view of decision parameters that may be included within the methods and systems of the gaming platform.

FIG. 5 depicts one data visualization technique using gaming platform data relating to longitudinal usage levels.

FIG. 6 depicts a sample embodiment of visualizing data derived from the gaming platform where the data relates to a game player's performance within a health education module of a game.

FIG. 7 depicts a sample embodiment of visualizing data derived from the gaming platform where the data relates to an education module of a game relating to diabetes.

FIG. 8 depicts an example user account page of the gaming platform.

### DETAILED DESCRIPTION

Detailed embodiments of the present disclosure are disclosed herein; however, it is to be understood that the disclosed embodiments are merely exemplary of the disclosure, which may be embodied in various forms. Therefore, specific structural and functional details disclosed herein are not to be interpreted as limiting, but merely as a representative basis for teaching one skilled in the art to variously employ the present disclosure in virtually any appropriately detailed structure. Further, the terms and phrases used herein are not intended to be limiting, but rather to provide an understandable description of the disclosure.

The terms “a” or “an,” as used herein, are defined as one or more than one. The term “another,” as used herein, is defined as at least a second or more. The terms “including” and/or “having”, as used herein, are defined as comprising (i.e., open transition). The term “coupled” or “operatively coupled,” as used herein, is defined as connected, although not necessarily directly and not necessarily mechanically.

The terms “user” or “player,” as used herein, are defined as someone who plays a game created with the gaming platform or visits a website from which such games may be played or otherwise expresses interest in playing such a game.

The terms “client” or “developer” as used herein, are defined as someone who uses or seeks to use the gaming platform for one or more of the following purposes: (1) to create or modify games or game components, (2) to change gaming platform settings, (3) to disseminate information about gaming platform games, and/or (4) to solicit people to play games using or created through the use of the gaming platform.

The term “computing device” as used herein, is defined as a computer or a mobile device such as a tablet, smart phone, personal media player, or the like. Such computing devices may operate using one or more operating systems, including Windows, MacOS, Linux, Unix, iOS, Android, Chrome OS, Windows Mobile, Windows CE, Windows Phone OS, Blackberry OS, and the like.

The present disclosure discloses a gaming platform that is enabled to facilitate customization of games, gaming content, gaming data and user interfaces for presenting gaming data, including client-oriented adaptation of gaming content, within a scalable, secure computing environment that is further enabled to embed customized games and gaming content within an extant client computing environment, such as a company website. The gaming platform may use a modular approach to build and manage games wherein each game draws on a menu of game components. These game components are created and updated independently of one another and then combined to form games or substituted for one another in existing games to form new games. These components may include functional elements, game content, game difficulty, branding elements, advertising elements, and other game characteristics. The gaming platform may combine any number of these game components to create and manage games without the necessity of additional programming, debugging, or other technical expertise beyond the knowledge of how to use the gaming platform's user interface.

The gaming platform's functionality may be enabled by various engines, which may consist of software and hardware. These engines may include a gaming engine that manages the overall functionality of the game, accessing other engines, such as a question engine, an analytics engine, a social features engine, a content engine, a demographic engine, an alert engine, a rules engine, an inference engine, among others. These engines are modular in design and are called upon by multiple games to perform functions for those games, such that a client who has developed multiple games may run one copy of each engine in support of all of those games. These engines may be designed to run seamlessly with one another, such that no additional programming is required to enable a game to make use of these engines. In embodiments, a new game may be created or an existing game may be changed through a simple client interface from which engines and content may be designated for that game. In an example of these embodiments, a single-player game could be enabled for multi-player use by activating an appropriate engine. In another example of these embodiments, an existing game that does not send text message notifications to players could be enabled to do so by giving it access to an alert engine. In some of these embodiments, new engines may be created that seamlessly integrate into existing and new games running on the gaming platform. In an example of these embodiments, a translation engine is used so that existing and new games may offer their content in different languages. In another example of these embodiments, a voice recognition engine is added enabling existing and new games to accept spoken input. In addition to being accessible by the gaming engine, the other engines may access one another directly.

In embodiments, the gaming platform provides a secure single-sign-on protocol and other security features, integrates multiple sources of gaming content and other content from multiple content developers, and provides other features to enhance the ease of use and enjoyment of users, including the exchange of user-specific data and other gaming-related data. In embodiments, the gaming platform is configured to accommodate existing industry applications to improve efficiency in distributing content to specified users and for other purposes.

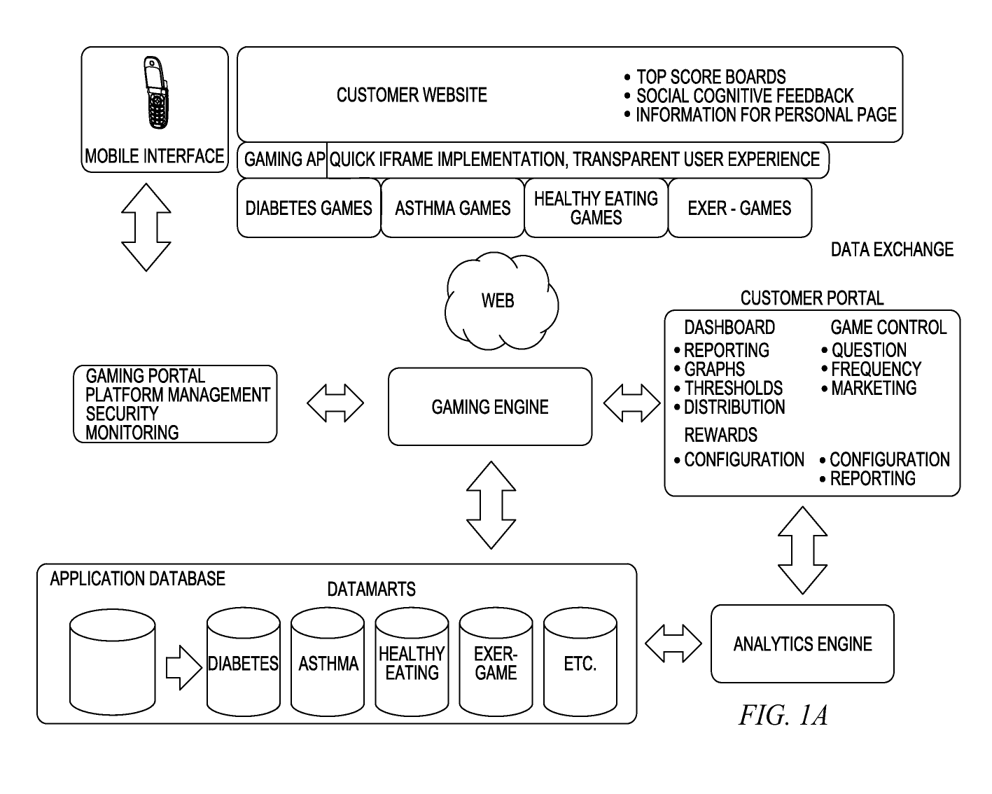

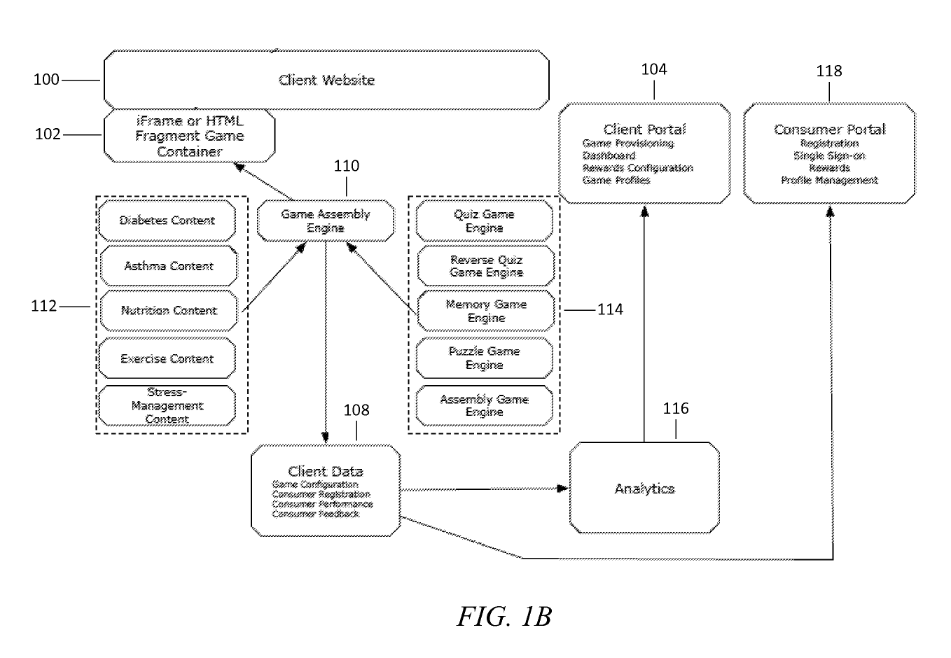

Referring to FIG. 1A, the gaming platform provides core software to an embeddable, customizable gaming system that integrates a gaming engine with a gaming API, an application database, a developer or customer portal, a client or customer portal, a gaming portal, and an analytics engine, a mobile interface, among other facilities of the gaming platform. The gaming engine draws from a wide range of modular components to create customized games. In embodiments, the gaming platform provides users with features such as performance data, rewards and game-control information, in addition to other data. In examples of these embodiments, the gaming platform may use iFrames within a presentation layer of the gaming platform to make aesthetic, navigational and other adjustments to a user interface and to deliver other parameter data relating to game function and content.

Referring to FIG. 1B, in embodiments, the gaming engine presents one or more games to users via a client website 100. Such a website may include one or more containers 102. Such a container accesses a game assembly engine 110 component of the gaming engine, which in turn accesses a client data repository 108 to determine which game type 114 the client has specified for the container in question. The game assembly engine also determines what game content 112 to include in the game being assembled and then merges that content into the appropriate game type template and other game components and requirements to create a properly formatted game in the container. In these embodiments, as players interact with the games on a client website, information about each player's identity, history of play, proficiency data, reward achievements, and other player-specific data may be stored in the client data repository 108. An analytics engine 116 may analyze these data and furnish the resulting analysis to a player in graphical and quantitative form. In examples of these embodiments, the container may consist of an iFrame, an HTML Fragment, or other shell or repository through which the game may be presented to a player. In some of these embodiments, players may use a player or consumer portal 118 to access the data pertaining to them that is stored in the client data repository, including their personal data, including their identity, history of play, proficiency data, and reward achievements.

In embodiments, the gaming platform's gaming engine, as described herein, is designed to support multiple conditions and games and for other purposes that require an adaptable, customizable platform in order to meet a gaming client's needs. The gaming platform is associated with a business layer that may reside outside of the presentation layer and that is designed to integrate content within games developed within the gaming platform, or other applications, track player activity, service client needs, or perform some other type of functionality. Thus, the gaming platform is adaptable and applied to a variety of games and types of applications without requiring de novo game development and software coding.

In embodiments, the gaming platform, as described herein, is configured to accommodate new applications from a plurality of developers, and may allow for the efficient integration of new content (e.g., artwork or questionnaire data) and other customizations as a client's needs may require.

In embodiments, a question engine is used to collect and distribute information between users and the gaming platform. Information requests are customized to accommodate different specifications and generate content that may adapt functional aspects of gaming applications, such as the difficulty of game play, setting goals for users or other purposes.

In embodiments, a survey function of the gaming platform may facilitate interaction with users by delivering questions, information or other content. A video distribution system may deliver training, educational content, pictures and other information. The survey function and video distribution systems may work together to inform users and assess user performance in addition to delivering and collecting other forms of information.

In embodiments, a personal page feature of the gaming platform may allow developers, content providers and others to engage with users by providing feedback, tracking user performance, delivering survey answers, personal goals, comparisons to group answers, or utilize the personal page for other purposes. User data, such as scores or other data, are passed to a client's platform (e.g., a client website) via XML, or some other protocol, in a customized interval. User data is collected for the purposes of compiling leader boards or other data sets where data delivery is based at least in part on utilizing a tool, such as, iFrame. Developer-provided raw data or other methods are used to populate a client's unique leader board, rewards program design, performance metrics, or for some other purpose. The gaming platform may employ a plurality of methods for implementing this functionality. For example, the gaming platform may integrate data into another party's existing rewards platform by passing data to that party's platform using XML, or other defined protocol, in a customized interval. In some of these embodiments, the gaming platform may insert an iFrame into a pre-existing platform (such as web site, smartphone application or other platform).

In embodiments, the gaming platform is delivered via a plurality of client devices, including but not limited to mobile or other devices and is used to integrate data from external devices, such as pedometers, tracking logs and other devices within the gaming platform. In embodiments, a client device is a personal computer, laptop computer, tablet computer, mobile communication facility, electronic book reading device, television, GPS navigation aid, or some other type of computing device. A mobile communication facility may include, but is not limited to, a cellular phone, a GSM phone, a smartphone, or some other type of mobile communication facility.

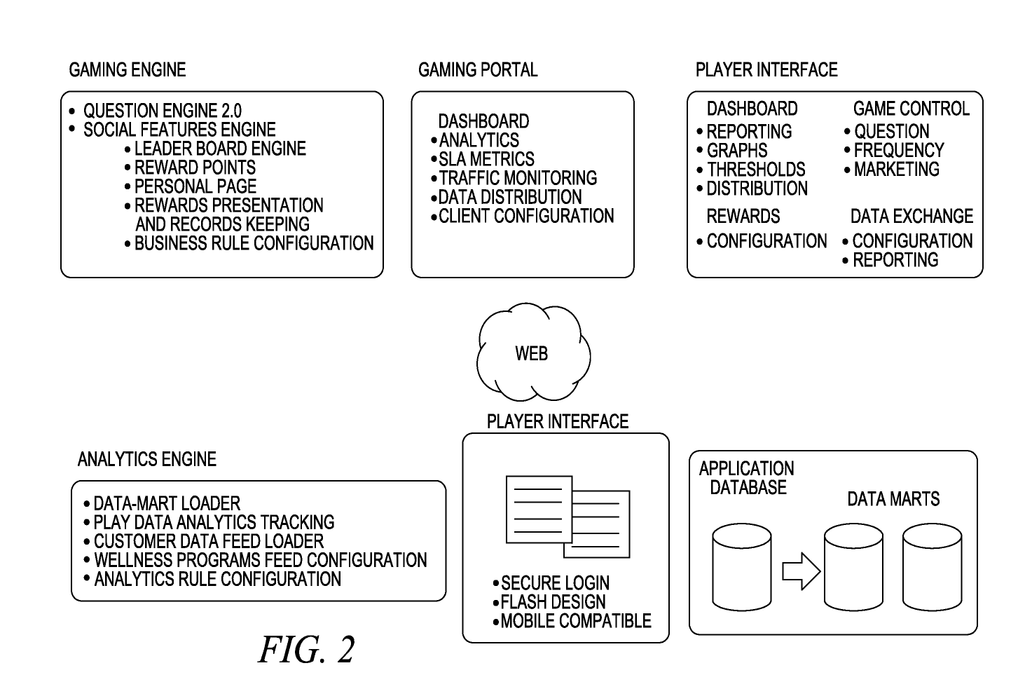

Referring to FIG. 2, the gaming platform may employ architecture to accommodate data reporting and client data integration by structuring and tagging data so that clients may use the data to conduct their own analysis or for other purposes. A security system may reside within commercial cloud computing systems that are configured to a client's desired standards and specifications. In embodiments, developer data may reside in a MySQL database, or some other data storage means, that employs data security procedures. Security systems associated with the gaming platform may allow for file backup (local or remote to the gaming platform, and/or client platform), and raw data access for administrators or others. Security is configured to mask identifiable player data, for example by employing a blend of waterfall and agile development methodology to remove defects and increase efficiency of development.

In embodiments, as illustrated in FIG. 2, the gaming engine of the gaming platform may include, but is not limited to a question engine, a social features engine, or some other type of gaming engine functionality. The social features engine may include, but is not limited to, a leader board engine, reward point calculation and storage, a personal page (as described herein), business rules, or some other gaming functionality.

In embodiments, as illustrated in FIG. 2, the gaming portal of the gaming platform may include, but is not limited to a dashboard, analytics functionality and reporting, SLA metrics, traffic monitoring, data distribution, client configuration, and other functional elements.

In embodiments, as illustrated in FIG. 2, the player or user interface developed by the gaming platform may include, but is not limited to a dashboard that is enabled to provide, at least in part, reporting, graphing, threshold analysis, distribution, rewards configuration, or some other functionality. The player or user interface may also include game control relating to the gaming content (e.g., questions) and gaming rules (e.g., the frequency and type of gaming questions presented to a user). In embodiments, the player interface may also enable marketing functions and the presentation of marketing or sponsored content to users. In embodiments, the player interface may enable data exchange, including configuration and reporting, and a secure login protocol, such as an internet-based login protocol for accessing the gaming platform from a client device.

In embodiments, the analytics engine of the gaming platform may include, but is not limited to, a datamart loader, tools for tracking and analyzing users'game play data, an analytics rules engine, statistical processing tools, or some other type of data analysis tool. In embodiments, game usage patterns are obtained from a database of user profile data that is associated with the gaming platform and/or metadata relating to users of the games created by the gaming platform. A wide range of usage patterns are used to assist with retrieval and presentation of content to users, such as educational content relating to a medical condition, sponsored content that is relevant to a user, or some other type of content or data. The analytics engine, as described herein, may include one or more modules or engines suitable for analyzing game usage patterns to assist with determining, selecting and presenting relevant content. For example, the analytics engine may analyze game usage patterns based on time of day, day of week, day of month, day of year, work day patterns, holiday patterns, time of hour, patterns surrounding transactions, patterns surrounding incoming and outgoing game content and results, patterns of clicks and clickthroughs, patterns of communications (e.g., Internet, email and chat), client device type used to interact with a game, and any other patterns that can be discerned from data that is used within, or in association with the gaming platform and games that created and/or managed using the gaming platform. Usage patterns are analyzed using various predictive algorithms, such as regression techniques (least squares and the like), neural net algorithms, learning engines, random walks, Monte Carlo simulations, and others as described herein.

In embodiments, an API, or plurality of API's are provided to enable and facilitate the management and use of user data, such as user profiles, and the operation of content syndication within or in association with the gaming platform.

The gaming platform may include a configurator that allows multiple games to be created using the same back-end datamarts, databases, and other facilities of the gaming platform, and allows multiple games to share some of the same elements, including without limitation content, logical algorithms, data (e.g., text-based questions, images, and multimedia content) and user interfaces. In some embodiments, games are created by combining a two-dimensional array of game elements, such as by combining a content set with a game structure. In an example of these embodiments, a game is created by combining a smoking-cessation data set with a quiz-style game structure to create a game that quizzes players on smoking cessation facts. In other embodiments, games are created using a multi-dimensional array of game elements, such as by combining a content set, a game structure, and artificial intelligence algorithm, branding information, a difficulty level, and customized advertising.

In embodiments, the gaming platform may accept, store, process, and deliver game-related data to players including, without limitation, text, graphics, video files, audio files, vector data, and numerical measurements. The gaming platform may store such game-related data on servers, allowing the software installed on the size of files stored on the player's computing device to be kept to a minimum. The gaming platform may also allow content to be updated without requiring that software be re-installed and without disrupting players use of the software. For example, content problems may be fixed without the need to reinstall or to update the game application. Fresh content is delivered seamlessly to the user, again without the need to reinstall or update the application. From the player's perspective, fresh content may simply appear on a regular basis. The gaming platform may also download and cache a local copy of the content it needs, which reduces the load on the server, and, in the case of mobile games, could allow the game to continue to function when a network connection is unavailable. In an example of these embodiments, the game assembly engine may assemble a “select the most correct” answer game in which multiple short video clips are shown, each presenting a person explaining how peer pressure can influence smoking. Of the three clips, one may contain the most accurate presentation. The player is asked to watch the three clips and to select the one with the most accurate presentation. In this example, a player who selects the correct answer is given reward points. In these embodiments, the same video clip content may be used in other games with different functionality. For example, there may be a crime-solving game in which the murderer is pretending to be a doctor and the player must interview doctors to find out which one is a fraud. The doctor interviewed who gives the least accurate presentation on smoking cessation would be the most likely to be the murderer posing as a doctor.

In embodiments, the gaming platform may provide quiz questions and answers to a player where the questions and answers reside on a server and administrator pages provide the ability to enter and change questions and answers, and upload files of questions and answers for mass-import. These files of questions are in comma-separated value (“CSV”) format, extensible markup language (“XML”), or some other format. The fields in which data are stored is specific to a single industry, such as medical data, or data generalized to allow for quiz questions and answers across multiple industries. Other examples of these embodiments may include educational games, strategy games, adventure games, or some other type of game. In other embodiments, games are created that follow other formats, including: a reverse quiz game that presents answers instead of questions; a memory game that allows a user to match questions and answers by turning over two cards at a time and remembering where questions and answers are concealed; a puzzle game where the game presents a question together with a collection of jigsaw pieces that the player must assemble to show the completed answer; an assembly game that presents a question and an image comprised of three or more sections that allows a player to flip each section individually until all three sections form a complete answer to the question; a choose-best-from-list game, where a list of statements are presented and the player must select the most accurate one; and a which-does-not belong game in which the player is presented with a list of statements or other data and must select the item from a list that is most dissimilar to the other items on the list.

In embodiments, the gaming platform may enable the creation of multi-level games, in which more difficult game content is presented in later levels. The content management tools may allow each piece of game content (e.g. a question and its answers) to be assigned a difficulty level. In these embodiments, the gaming engine may track a player's progression through multiple levels of a game, and present progressively more difficult content at each higher level. The player may see which levels they have completed, replay a previous level to obtain a better score, and only play a higher level when the level before it has been completed (“unlocked”). In embodiments, as illustrated in FIG. 1B, the system may record all play-throughs (and attempts) of all levels in the client data repository 108, enabling the analytics engine 116 to calculate player improvement.

In embodiments, the gaming platform may enable players to play the first level of a multi-level game before registering, which may draw new players into the game and reduce barriers to beginning play. In these embodiments, as illustrated in FIG. 1B, the client website 100 is enabled to allow a new player to play the first level of a multi-level game without registering. At the completion of level 1, the player is then asked to register in order to progress to level 2. All player data from the completion of level 1 is preserved in client data repository 108 under the now-registered player's identity.

In embodiments, the gaming platform is enabled to organize game content into (a) knowledge, (b) preference, and (c) commitment. In these embodiments, the content management tools may allow each piece of game content (e.g. a question and its answers) to be designated as falling into one of these three designations, where (a) knowledge consists of information for the player to learn; (b) preference consists of choices the player makes in real life that are gathered by the system and are used to generate analytics on players; and (c) commitment designates a promise the player makes for self-improvement, intended to drive behavioral change.

In embodiments, the gaming platform may enable the synchronization of game content between multiple server instances. In these embodiments, a private server instance is set up for each client. As illustrated in FIG. 1B, such a private server instance may contain the client data repository 108 and that player's game content 112. This separation of instances may provide data security by enabling a client to access only its own data and not that of other clients. A synchronization system may allow game content entered on one server instance (e.g. a set of questions and answers related to one topic) to be copied and updated to one or more other server instances. This synchronization may enable a number of scenarios, including master-slave(s) synchronization (a) and peer-to-peer synchronization (b). In such master-slaves scenario (a), a game content “master” server can be used to centralize adding and updating game content in one place. The synchronization system may allow the improved game content to be made available to all other client servers without compromising player data security. In such peer scenario (b), the platform would enable a client to maintain its own game content, and then to make it available selectively to other clients or to the gaming platform owner or administrator.

In embodiments, the gaming platform may enable additional analytics. These additional analytics are made available to players via a player or consumer portal 118, as illustrated in FIG. 1B. In an example of these embodiments, a player may select a category and scroll through all questions that player answered. The player may see the answers given, whether those answers are correct, and percentages of players that made each answer choice. In another example, players may review the preferences they stated and the commitments they made.

In embodiments, the gaming platform may support the use of profiles, scales, and content-selection algorithms. Such profiles may include data specific to the player, industry-based data that are relevant to the player. Such scales may include measurements based on player actions and other inputs, where the scales could apply across categories or across games. For example, one scale could include a leaderboard that showed the best performers across multiple games, another scale could include weight-loss performance of players playing different games designed to educate players about healthy eating and exercise, and a third scale could show the player's click-through rates for various types of in-game advertisements. Such content-selection algorithms may use factors including difficult settings, past performance of the user, and administrator input to determine what content to deliver to the player. For example, in a quiz game, selection criteria based on question diversity weighting could be used to deliver questions to the player that the player has not seen previously or previously answered incorrectly. In this context, “question diversity weighting” means any categorization of a question that can be specified by an algorithmic rule. For example, in a quiz game, “player proficiency” could be defined as a ratio of questions answered correctly to total number of questions answered and “question exposure” could refer to the ratio of questions the player has answered to the total number of questions in a subject area category.

In embodiments, the gaming platform may accept input from electronic devices including health-monitoring devices worn or used by players. Such health monitoring devices may include glucometers, tracker devices like the FitBit, pedometers, heart rate monitors, thermometers, blood pressure monitors, perspiration monitors, treadmills, rowing machines, and other internet-connected exercise equipment.

In an example of how the gaming platform's data processing and delivery features may be used, a health quiz game designed to improve the players' health-related practices and activities could include a matrix of player health data and may use past responses to select content to be delivered to the player with the goal of providing the user with information and other feedback. Such content may include quiz questions that the player previously answered wrong, new quiz questions, badges or other rewards designed to incentivize player behavior, and the unlocking of new sections of the game.

In embodiments, content is identified and tracked by version, allowing a game to determine automatically whether new or changed content needs to be downloaded. This embodiment could also allow new content to be added via the client or customer portal in advance, and scheduled for release to players at a specified future date and time, supporting the goal of real time changes to game content. This version-tracking feature also enables processes by which content is approved by multiple people before release. In such an approval process, one person could enter content, a second person could change and approve the content, and a third person could schedule it for release on a specific date and time.

Embodiments of the disclosure may include a number of features designed to facilitate deployment of games using the gaming platform. These deployment features may reduce the effort required to go from the initial game idea to having a fully branded, configured, and deployed game. These deployment features may include (1) tools to allow game developers to control the timing, rollout, and updating of games; (2) tools to ensure the stability of games, including the ability to roll back to a previous version of a game if an update causes problems without having to alert players and without players having to re-install software; and (3) simple controls that allow game developers to deploy games without reliance on technical staff, such that non-technical users could upload and deploy new games with a single mouse click.

The gaming platform may offer scalability features designed to support a wide range of game developers from developers with only a single game on a single web site to large-scale users with many games on many sites. Game developers may allow players to sign onto multiple games with a single player identity (user name and password) and may synchronize databases across multiple games and web sites. Such database synchronization may assist game developers in targeting marketing to players, analyzing player behavior, and performing other analytics helpful in planning improvements to the game experience and increased monetization of the game.

In embodiments, the gaming platform would allow players to purchase and download applications and updates.

In embodiments, the gaming platform may allow game developers to deploy new game versions for testing without disturbing the stable production version used by current players.

The gaming platform provides tools for the identification of players. Such tools include allowing game developers to assign a single log-in based on a simple user name and password scheme to one player across multiple games using the gaming platform and allowing players to assign a nickname (“handle”) that can be made visible to other players.

In embodiments, these player identification tools offer game developers the choice whether to track the real-world identity of game players. In some examples, game developers may wish to track players' real-world identities for marketing or other purposes. In other examples, game developers may wish not to track player identities in order to provide maximum protection for player privacy and in order to comply with applicable privacy laws and regulations.

In embodiments, the gaming platform may allow game developers to link multiple player identities, such that a player with an existing identity may choose to use that identity or to create a new one when starting a game.

In embodiments, the gaming platform may allow user identities to be integrated with other networks and services, such as Facebook, Google+, LinkedIn, and Twitter.

In embodiments, the gaming platform may provide the option of players receiving updates by email, text message, or other electronic means through an integrated player communication system. An example of such a player communication system would allow players to enter an email address at which the player would like to receive game updates and to activate the email address by clicking a secure link that is emailed to the player by the gaming platform.

In embodiments, the gaming platform may provide tools for game developers to allow players to sign in using OpenID.

In embodiments, the gaming platform may provide game developers with a simple interface for entering a privacy policy and sharing that privacy policy with players.

The gaming platform may offer multiple success indicators for measuring player performance and providing players with feedback. Such success indicators may include, in embodiments: (a) high score and leaderboards that rank players against one another, identifying the top performers by their handles; (b) indication of personal progress toward measurable goals, which goals in some implementations can be set by the individual player; (c) achievement indicators (“badges”) that are displayed in a player's public profile, such that other users can see that the player in question has achieved certain performance benchmarks associated with completing a specific task within the game; and (d) integration with external sites to provide tangible rewards, such as frequent flyer miles and points that are turned in for prizes.

In embodiments, the gaming platform may provide game developers and administrators with tools to track and analyze player behavior, which is helpful for purposes of measuring (1) player engagement, including acquisition, conversion and retention; (2) player progress, including behavior change, habits, and outcomes; and (3) customized analytics that are designed to provide data sought by a particular game developer or administrator. These tools for tracking and analyzing player behavior may include (1) options to export player data in standard formats, such as CSV; (2) a reports feature in the administrator interface that allows game developers and administrators to display and to print individual and aggregate player data in graphical and spreadsheet formats, using real-time data or data for a specific time period; and (3) algorithms to analyze player data to identify patterns and to recommend changes to improve player experiences and outcomes. Such export options, report features, and algorithms could be applied broadly to all available data or could be filtered using on-page controls to a desired subset of available data. Such on-page controls could also be used to sort data based on criteria set by game developers or administrators. In examples of these embodiments, reports could indicate (1) the number of new players, (2) the duration and frequency that players play the game, (3) the relative game balance, as indicated by points at which play drops off due to the difficulty level increasing to the point where players abandon the game; (4) the rate at which players who are playing free versions of games purchase paid features; and (5) the effect of game changes on player engagement.

In an example implementation involving a game designed to improve player health and health-related behavior, the game administrator could be a health care provider and one measurement of player progress could be whether a player achieved a desired health-related outcome, such as weight loss.

The gaming platform may provide multiple tools to assist game developers in developing games. These tools may include (1) a Developer Web Site designed to reduce barriers to software development and to reduce support costs through self-help; (2) a Software Development Kit (“SDK”) containing a library of code samples that can be plugged in to perform a variety of basic functions common to multiple games, saving developers the time and effort that would be required to create code to perform these functions; and (3) a fully-functional reference implementation game, complete with the game's software source code, that can serve as an example application for developers.

Such a developer web site could include: (a) site registration that provides each developer with a key that is used in all communication between games developed by that developer and the platform servers, said key providing authentication, traffic measurement, and other benefits; (b) platform documentation describing the capabilities of the gaming platform, as well as specific technical documentation on how to use the platform's capabilities in software, such documentation possibly including a “Game Developer's Overview,” which could be provided in HTML, PDF, or other form, and an interactive Wiki to which developers could contribute articles and comments; (c) access to platform software, including code samples, the SDK, and the reference implementation; and (d) other features, including a developer forum where developers could interact with one another and technical representatives of the entity managing the implementation of the disclosure, a knowledge base, bug tracking and reporting, and other features that are of use to developers.

Such an SDK could encapsulate the details of the gaming platform's application programming interface (“API”), so that game developers do not need to learn the API's low-level details. In cases of mobile applications, the SDK may provide ready-made solutions to programming problems like storing game outcomes at times when an Internet connection is not available, such that those outcomes can be transmitted to the server when an Internet connection becomes available.

Such a reference implementation could be designed to highlight how to make use of all of the platform's capabilities and, if made available to a broad audience, might have the added benefit of generating interest in the platform among developers and players. In embodiments, the reference implementation could be developed using a programming environment such as Sencha Touch, which allows the creation of games that work on Android, iOS, and other mobile/web platforms and makes use of current Internet technologies, including HTML5 and JavaScript. An example of a possible reference implementation would be a trivia game.

In embodiments, the gaming platform may include state of the art security features. For example, data could be encrypted by the front-end software and unencrypted by the back-end server only to the extent necessary for analytics and scoring features, preserving player privacy and the integrity of confidential player information.

In embodiments, the gaming platform may feature an automated cloud-based backup process that preserves data in case of damage to the player's computing device or loss of server data. Such a cloud-based back-up process would help to avoid the uncertainty of a manual back-up process that is subject to human error. In an example implementation of such an automated cloud-based backup process, game administrators could be prompted by the software on a regular basis to perform test restorations of backed-up data to ensure the continuing integrity of the backup process.

In embodiments, the back-end system may include three components: (1) an HTTP/XML API that is used by front-end systems for things like scores and leaderboards; (2) an Action Message Format (“AMF”) adapter, which is used by Flash games; and (3) a set of administrative pages used to maintain data at to perform data export functions, including exporting to CSV and XML formats for data reporting. In an example, the back-end system could be developed using a development system, such as Ruby on Rails, could include a significant amount of testing code, could use a MySQL database to store its data, and could be designed for optimal flexibility in establishing new data relationships to extend its capabilities.

In embodiments, the database(s) associated with the gaming platform may support the following features: (1) a back-end instance may support multiple applications and multiple sites where linked games appear, such that players and their scores and points are separated across these sites while the same data are being shared across multiple sites and (2) data is grouped into categories. In an example of these embodiments involving a quiz game, players on multiple sites could answer the same questions and the questions could be grouped into categories that were the same across all sites, but player scores would be ranked only within the site on which they were playing, such that the leaderboards for each site would be different.

In embodiments, a front-end game may include PHP pages and a library of common PHP code that keeps content, including HTML and PHP, separate from style information, such as cascading style sheet (“CSS”) pages. The front-end may also use a model view controller (“MVC”) framework, such as Zend, Codelgniter, or CakePHP to make the code easier to maintain and to extend and to separate model (data) concerns from controller and view (routing/presentation) concerns.

In embodiments, a development system such as Ruby on Rails is used for the development of front-end sites.

In embodiments, a web-based game is embedded into a web page via an HTML iframe. In other embodiments, a game is compiled into an application running on a computing device. In still other embodiments, a game is served to a computing device using an interface and communication protocol that does not involve a web browser.

In embodiments, the gaming platform is integrated in a simple, secure manner with multiple front-end technologies, including standardized technologies such as HTML5 and JavaScript, as well as proprietary technologies such as Adobe Flash, Oracle Java, and Oracle Java Server Pages (“JSP”), such that the front-end portion of the code interacts seamlessly with the bank-end server-based code.

In embodiments, the gaming platform could make use of (1) Ruby on Rails to develop the core back-end platform, (2) MySQL as the database, (3) Capistrano for back-end deployment and rollback, (4) Git for source-code control, either via Github or using a private server, (5) local caching to reduce server load and to increase server availability, (6) RSpec, Capybara, Selnium, and RUnit for testing at a code-to-test ratio of 1:1; (7) Cerebus or a similar product to provide continuous integration; (8) Nagios or a similar product to provide operational monitoring and outage notification; and (9) JSON to provide object access either by itself or in conjunction with XML.

In embodiments, updates is released in small increments every one to two weeks with early and frequent feedback from front-end developers and collaboration among developers, refactoring, continuous integration, and automated one-click deployment.

In embodiments, the gaming platform may include state of the art security features, such as data encryption to preserve player privacy and the integrity of confidential player information and the gaming platform is regularly reviewed for security vulnerabilities that would allow player data to be stolen or inadvertently disclosed.

In embodiments, the gaming platform may feature an automated cloud-based backup process that preserves data in case of damage to the player's computing device or loss of server data. Such a cloud-based back-up process would help to avoid the uncertainty of a manual back-up process that is subject to human error. In an example implementation of such an automated cloud-based backup process, game administrators could be prompted by the software on a regular basis to perform test restorations of backed-up data to ensure the continuing integrity of the backup process.

In embodiments, the gaming platform may enable a functional flow that includes the following elements:
(1) An administrative interface that allows game administrators or other authorized persons to update content through a web browser-based administrator interface. Using this interface, game administrators may add, edit, or delete content. Content is edited or entered on screen or is uploaded. Such uploading of content may take one of many forms, including individual file uploads, batched uploads, or database file uploads.
(2) A data validation process in which the content server ensures that data entered or uploaded adheres to normalized forms, allowing the same content to be used in multiple game formats without rewriting or editing content for each new game format.
(3) A web-browser-based console that is used by game administrators to refine or modify content and to approve content for use in games.
(4) An API that connects applications to the content server either directly or using code from the SDK. A game may request the content server to provide a set of content elements, including text, graphics, video files, audio files, vector data, and numerical measurements. For example, in a quiz game, the content server may provide a specified number of questions distributed between questions that are new to the player and questions that the player previously answered incorrectly based on a diversity weighting percentage.
(5) The player may play the game using the content provided by the server. Depending upon the type of game and the amount of time played, the game may request and retrieve additional data from the content server.
(6) At the conclusion of the game, the game may reconnect to the content server, uploading the player's performance data. The server may then calculate the player's normalized score and provides it to the game through the API.
(7) Game administrators or other authorized persons may use a web-browser-based console to review analytical data across all game activity. The console allows them to break down activity by game, player, score, player demographics, scale, or game-specific characteristics. For example in a quiz game, activity could be broken down by question topic.

In embodiments, the determination of relevance, relevancy, associations, correspondence, and other measures of correlation and relationships between gaming content, users, and metadata associated with both, as described herein, are made based at least in part on statistical analysis. Statistical analysis may include, but is not limited to techniques such as liner regression, logistic regression, decision tree analysis, Bayes techniques (including naïve Bayes), K nearest neighbors analysis, collaborative filtering, data mining, and other statistical techniques are used.

In an example, linear regression analysis is used to determine the relationship between one or more independent variables, such as user profile data, and another dependent variable, such as a datum associated with gaming content (e.g., health education question, game type, user interface type, and so forth), and modeled by a least squares function, called a linear regression equation. This function is a linear combination of one or more model parameters, called regression coefficients.

In another example, Bayes theorem is used to analyze user profile and/or gaming content data, such as contextual data that is associated with gaming content, data relating to user of a game or the gaming platform, or some other type of data used within or associated with the gaming platform. Using Bayes theorem, conditional probabilities is assigned to, for example, user profile variables, where the probabilities estimate the likelihood of a gaming content usage, the relevance of gaming content to a given user, or some other estimate type, and may be based at least in part on prior observations of the users' interactions with gaming content. Naïve Bayes classifiers may also be used to analyze gaming platform data. A naive Bayes classifier is a probabilistic classifier based on applying Bayes' theorem with strong (naive) independence assumptions. A naive Bayes classifier assumes that the presence (or lack of presence) of a particular feature of a class is unrelated to the presence (or lack of presence) of any other feature. For example, a gaming platform user, and user of a game developed using the gaming platform, is classified in a user profile as interested in cardiovascular care content if he has previously searched for, retrieved, downloaded, used, and/or interacted with cardiovascular related gaming content, and the like. A Bayes classifier may consider properties, such as prior interaction with cardiovascular gaming content, prior purchases of cardiovascular products presented as sponsored content within a game's user interface, searches for cardiovascular information, and the like to independently contribute to the probability that this user is interested in cardiovascular healthcare content. Once a classification is assigned within the user profile (e.g., User X=“cardiovascular patient”) that is associated with the gaming platform, the user's information is stored and shared by the gaming platform (e.g., sharing the data with other users of the gaming platform designing healthcare-related games and gaming environments, and/or sending the data to an ad server where the classification “cardiovascular patient”) and is used to select cardiovascular-related sponsored content to deliver to the user. A single user profile may include a plurality of classifiers. For example, the cardiovascular patient's user profile may also include classifiers indicating that the user is a “user of statins,” or a “cardiovascular rehabilitation participant,” and so forth, using the data that is associated with the user's actions and behaviors within the gaming platform and/or during game play, and any other data sources as described herein. An advantage of the naive Bayes classifier is that it may require a small amount of training data to estimate the parameters (means and variances of the variables) necessary for classification. Because independent variables are assumed, only the variances of the variables for each class need to be determined and not the entire covariance matrix. This characteristic of naïve Bayes may enable the classification.

In embodiments, a behavioral data analysis algorithm is used for developing behavioral profiles for gaming platform users and the users of games developed at least in part within the gaming platform. Behavioral profiles may then be used for targeting advertisements and other content to the game, and gaming platform users. A behavioral profile may include a summary of a user's activity within a game, or within the gaming platform, including the types of content and applications accessed, and other behavioral properties. The user's activity summary may include searches, browses, purchases, clicks, impressions with no response, or some other activity as described herein. The behavioral properties are summarized as continuous interest scores of a gaming content category, or some other property. Continuous frequency scores and continuous recency scores (e.g., how recently the activity occurred) are considered as behavioral properties for use in constructing a behavioral profile. A user's activity summary and the behavioral properties are categorized using the analytic techniques as described herein (e.g., naïve Bayes classifiers). Gaming content data, and its characteristics, and sponsored content that are associated with the presentation of gaming content to a user (e.g., an advertisement), may also be used for the generation of a behavioral profile. For example, data such as advertisement identity, ad tag, user identity, advertisement spot identity, date, and user response are used. In addition, content categories are used for targeting gaming content and/or advertisements based on a behavioral profile, or portion of a behavioral profile. Further, content categories are associated with each search, browse, download, purchase, or other online behavioral activities and/or transactions.

In embodiments, a program of automatically syndicating content with the user base of the gaming platform, and games created therein, is based at least in part upon the relevance of contextual data associated with the gaming content (e.g., “cardiovascular health education quiz game”) and information know about a user, or group of users (e.g., user profile data, as described herein). The automation of syndicating content is based at least in part on associating metadata with gaming content. Contained within the metadata is information regarding the relevance of the gaming content to various game users and/or game user groups. An example of only one of the many examples of how a metadata may contain relevance information may include: metadata indicating the relevance of gaming content to a website in which a game is embedded (e.g., “Hospital X Cardiovascular Care Group's” homepage), metadata indicating the average relevancy score that is associated with gaming content by a user from a given user category, and the like.

In embodiments the gaming platform may support single sign-on (SSO) to provide a functionality that may utilize security protocols and allow secure data exchange between the developer and client platforms. The platform may support unregistered anonymous play with client authentication, in which data is tagged with a unique user ID that is passed to the gaming platform during the authentication process.

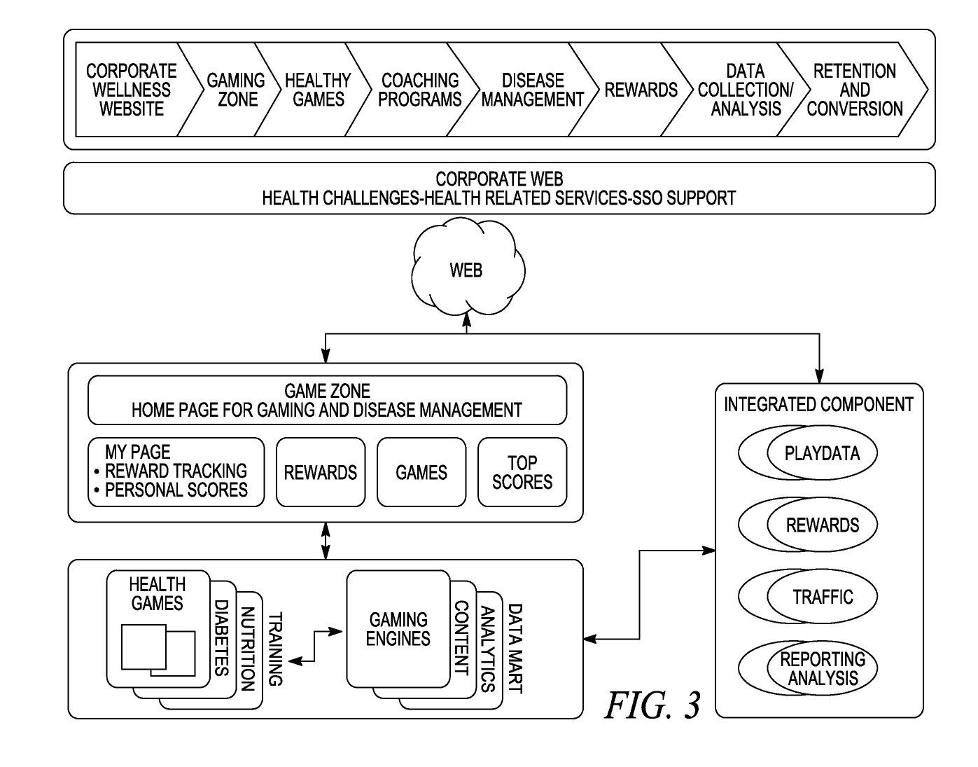

In embodiments, games developed using the gaming platform may enable disease and health management through game play and gaming content, and enable patient learning through the usage of user rewards and score tracking and comparison to indicate the level of health or other learning the user has achieved. In an example of these embodiments, one or more games may be offered through a health services web site, as illustrated in FIG. 3. In this example, a game zone is presented on a home page for gaming and disease management that offers a personalized page that users may log into that may include reward tracking and personal score information. Such a game zone may also provide information on rewards, games that are played through the website, and top scores for those games. In this example, the game zone may communicate with multiple game content files (e.g. diabetes, nutrition, smoking) and multiple game engines (e.g. content engine, analytics engine). In combination, these components of the gaming engine may produce and transmit reports on game usage, including play data, rewards, traffic, and analysis.

In embodiments, the gaming platform is used to provide a homogenous and transparent experience as the player navigates between the client and developer platforms. The gaming platform may employ style guides, avatars, and other specific creative content to customize applications. The gaming platform may employ standardized bidirectional API methodology between platforms to generate protocols operating between the business tier and the client platform to minimize impact as games, applications or other features are added to the gaming platform. The gaming platform may accommodate various scoring systems for games and other applications, and may use the API solution to calculate an exchange rate to convert points or other criteria earned while using an application into rewards or other benefits.

In embodiments, the gaming platform's methodology is applied to popular games and applications to convert them for use in delivering specified content or for other purposes. The gaming platform, as embodied here, may support many different types of applications and users, and may modify pre-existing applications to increase efficiency and speed of development to satisfy client needs.

In embodiments, the gaming platform may support unique identities to allow user customization and customization of games and game content. Platform architecture may support team and group formation and may also generate comparisons allowing players (or groups of players) to see how their answers to specific questions compare to other players in addition to other features. The gaming platform may also support avatars, points and other customizable features that can be redeemed for prizes, and other features that may allow individuals to develop an identity and a personal connection with the client's portal. In embodiments, content is loaded that is specific to an education and/or behavior change goal of a user. Using internal and external subject matter, content is built using the gaming platform, around care models, health education modules, or any other subject matter. In some of these embodiments, game content is designed for educational purposes, while in others it is designed for entertainment purposes or both educational and entertainment purposes. In other of these embodiments, games are designed to enable players to facilitate problem-solving, such as by applying the strategic decisions of game-players to solving scientific, mathematical, financial, or other problems. In an example of these embodiments, a mapping game is designed that determines the possible compounds that could be created through the combination and recombination of a given set of molecules.

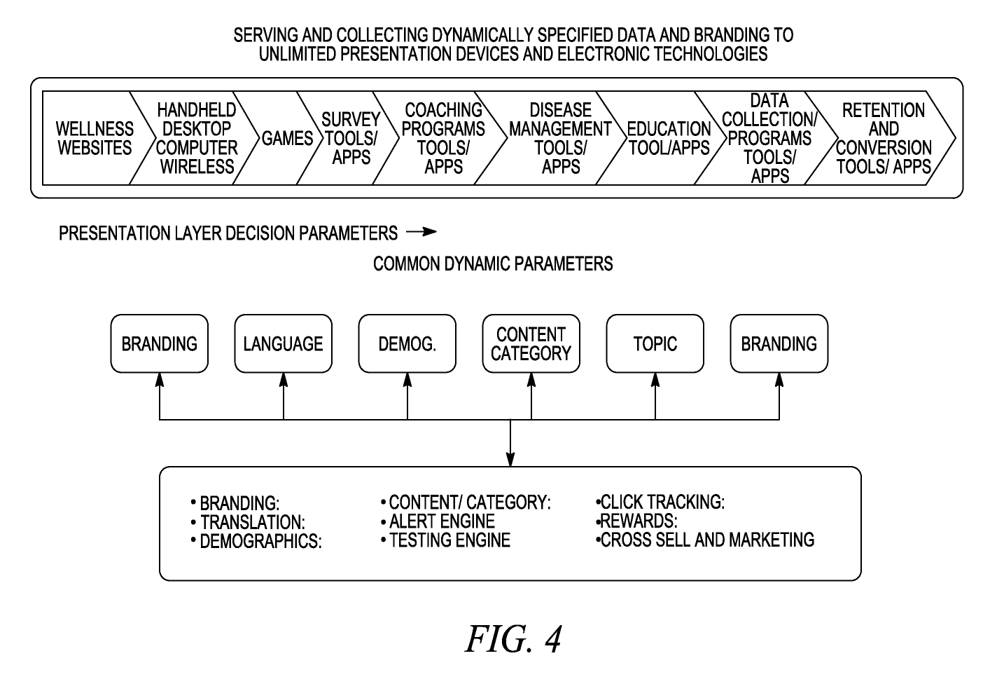

Referring to FIG. 4, in embodiments, games and game content are customized using dynamic parameters as inputs to the gaming platform, where the dynamic parameters facilitate the creation of a presentation layer of a game. The dynamic parameters are used, in part, to customize and adapt games, game interfaces, and game play and modules in order to attract specific segments of users, such as a specific gender, education level, or other user criterion. The gaming platform's data export and integration facilitates are used to correlate promotions or interventions with user data to measure impact on business goals and other factors, including increased enrollment in programs, improvements in health, increases in purchases, or some other outcome. Examples of dynamic parameters include, but are not limited to, branding, language type, demographics (e.g., of users), content type or category, topic information, or some other type of parameter. In embodiments, the gaming platform may have a plurality of parameters that are used to determine the actions of the gaming platform or related client platform. This includes but is not limited to the platform engines, client configuration, and any presentation layer or client device. Demographic data associated with users may include, but is not limited to, age, sex, race, religion, area code, zip code, home address, work address, billing address, credit information, family information, health care information, income information, birth date, birthplace, employer, job title, length of employment, and the like.

In embodiments, content may be served to the presentation layer of a game. In embodiments, dynamic branding may be served to a presentation layer and segmented by a unique client. For each user, a plurality of alternative branding may be determined by the gaming platform engines or parameters being passed to or through the platform.

In embodiments, the gaming platform may serve and store data, content, and branding information in any language. This may also be determined by a user's profile that is stored within the gaming platform. The gaming platform may enable real-time or batch mode translation of data or content being stored or sent to the presentation layers of a given game, game interface, or device. This may include the ability to translate data to one common language if the data is being retrieved or presented in multiple languages. The platform may translate from one language to many.

In embodiments, data, branding and content are presented and stored as determined by a demographic engine within the gaming platform. This may be parameter based.

In embodiments, content that is sent to the presentation layer, and respective data retrieved, is determined by parameters passed to the platform and/or the configuration of a user's profile. This may be parameter based.

In embodiments, the gaming platform may include an alert engine enabling clients to store or transmit alerts if data or its configuration indicates that a condition has been satisfied. This communication may include, but is not limited to, medical alerts, law enforcement, doctor follow-up, emergency services or any other type of communication that is defined within the gaming platform. This may be parameter based.

In embodiments, the gaming platform may enable the use of activities within the presentation layers or platform capabilities to add, modify, and/or configure data within the gaming platform, including user rewards, reimbursement of compensation programs, and the like. This may be parameter based. The gaming platform may enable marketing and cross-selling activities, including but not limited to using data from presentation layer activity, platform data/configurations to determine cross-selling opportunities, marketing opportunities (e.g., email campaigns) within the presentation layer.

In embodiments, the gaming platform may perform the methods and systems described on any wired or wireless network. In embodiments, the gaming platform may enable interfacing with additional tools, measuring devices or accessories and use their functionality to interface with other platforms (e.g., web hosting servers) or users' and clients' infrastructures and their related functionalities.

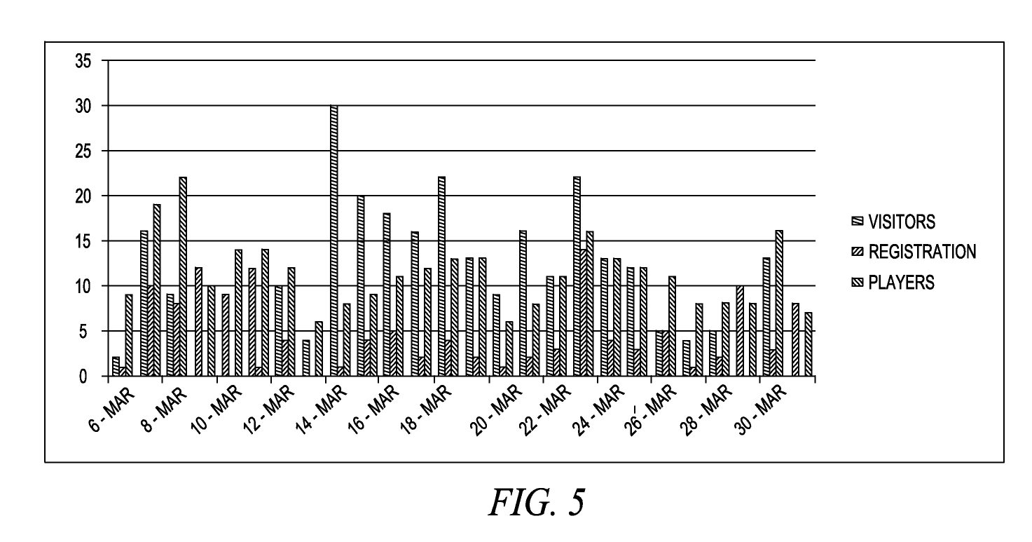

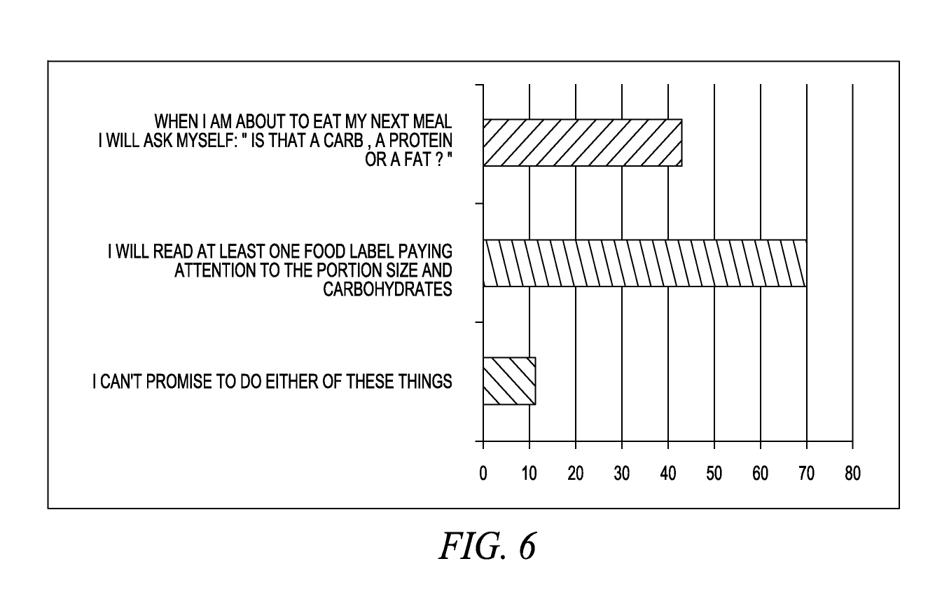

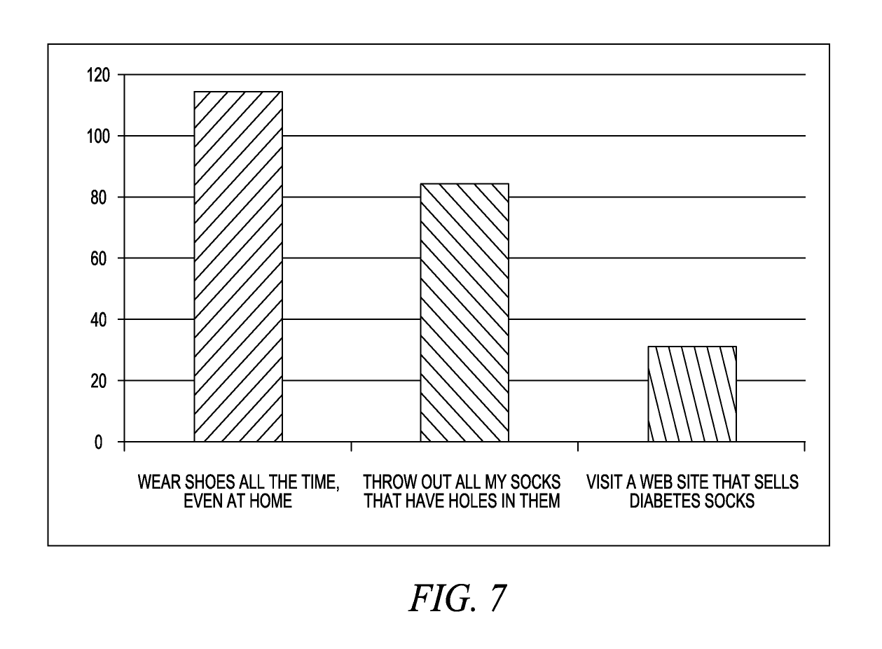

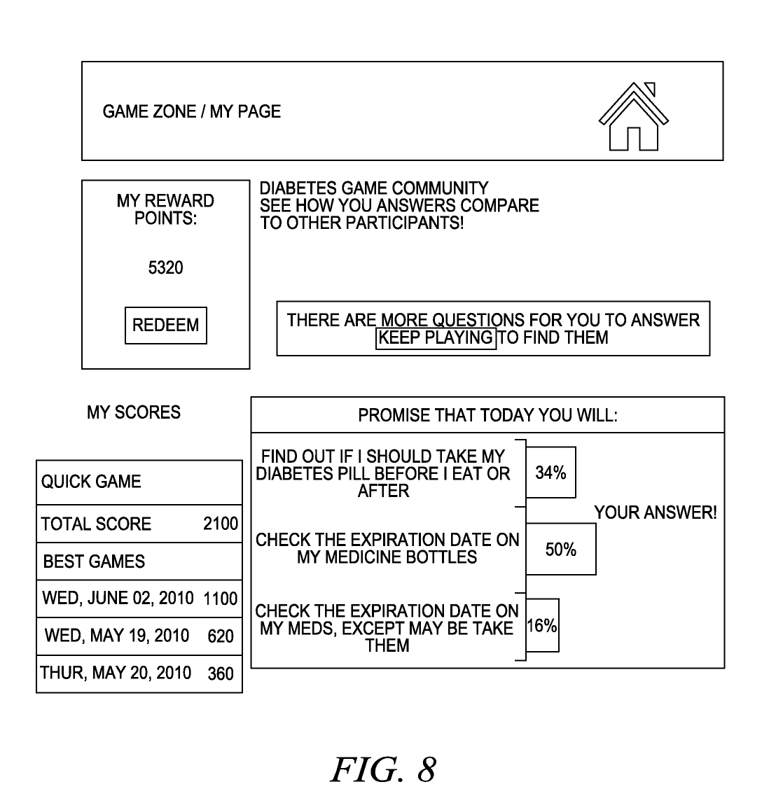

In embodiments, the gaming platform may enable a plurality of data visualization techniques for presenting user, gaming, or other data, including but not limited to game traffic, longitudinal usage and registration trends (as illustrated in FIG. 5), visualization of data derived from the gaming platform where the data relates to a game player's performance within a health education module of a game (as illustrated in FIG. 6), visualizing of data relating to an education module of a game, such as diabetes (as illustrated in FIG. 7), and/or a user account summary page indicating a user's game performance, reward totals, and comparison to other players or player groups (as illustrated in FIG. 8).

In embodiments, data integration techniques and methods are used as part of the gaming platform, as described herein, to collect, join, merge, validate, analyze, and perform other data processing operations for user data, client website data, gaming content data, user device data (e.g., applications used to interact with gaming content), and other data types as described herein. Data integration techniques and methods may be used to take the information collected from a plurality of data sources in order to draw an inference from the collected information, identifying a potential change to a database based on newly received information, and validating the change to the database based on the inference.

In embodiments, data integration techniques and methods are used to extract information from a plurality of user, client, and gaming data sources, and the like, the data sources having a plurality of distinct data types, transforming the data from the data sources into a data type that can be represented in, for example, a database to be used by the gaming platform, the database thereby integrating information from the distinct data types.

In embodiments the distinct data types are selected from a group consisting of gaming content data, user data, contextual information relating to gaming content, user behavioral information (including user profiles), demographic information, usage history, and other data sources and types as described herein. In embodiments, data integration techniques and methods are used to apply rules, such as by a rules engine, in connection with creation, updating and maintenance of a data set, such as one stored or used in association with the gaming platform. A rules engine is applied to secondary change data, that is, data that comes from one or more data sources and that indicates that a change may be required in a data set or to inference data, that is, data derived by inferences from one or more data sets. For example, a rule may indicate that a change in a data set will be made if a secondary data source confirms an inference, or if an inference is consistent with data indicated by a data source. Similarly, a rule might require multiple confirmations, such as requiring more than one data source or more than one inference before confirming a change to a data set (or creation of a new feature or attribute in the data set). Rules may require any fixed number of confirmations, whether by other data sets or by inferences derived from those data sets. Rules may also embody various processes or work flows, such as requiring a particular person or entity to approve a change of a given type or a change to a particular type of data.

In embodiments, data integration techniques and methods are used to extract information from a plurality of gaming-related data sources, the data sources having a plurality of distinct data types, storing the data in a common data set, considering a change request associated with a database, such as a database that is associated with the gaming platform, and using the common data set to validate the change request.

In embodiments, data integration techniques and methods are used to extract information from a plurality of gaming-related data sources, the data sources having a plurality of distinct data types, storing the data in a common data set, considering the common data set to identify potential changes to a database, such as a database that is associated with the gaming platform, and initiating a change request based on the common data set.

In embodiments, a data integration facility is used to integrate data from a plurality of gaming-related data sources, the data sources including attributes relevant to the gaming platform, wherein the data integration facility is selected from the group consisting of an extraction facility, a data transformation facility, a loading facility, a message broker, a connector, a service oriented architecture, a queue, a bridge, a spider, a filtering facility, a clustering facility, a syndication facility, and a search facility.

In embodiments, a data integration facility is used to integrate data from a plurality of gaming-related data sources, taking an inference drawn from analysis of data collected by a plurality of data sources, applying a data integration rule to determine the extent to which to apply the inference, and updating a data set based on the application of the rule.

In embodiments, a data integration facility is used to integrate data from a plurality of gaming-related data sources, taking an inference drawn from analysis of data collected by a plurality of data sources, applying a data integration rule hierarchy to determine the extent to which to apply the inference, and updating a data set based on the application of the rule.

In embodiments, a data integration facility may provide a rule hierarchy to determine a data type to use in a data set related to a system, such as the gaming platform, the rule hierarchy applying a rule based on at least one of a data item, the richness of a data item, the reliability of a data item, the freshness of a data item, and the source of a data item and representing the rule hierarchy in a data integration rule matrix, wherein the matrix facilitates the application of a different rule hierarchy to a different type of data.

In embodiments, a data integration facility is used to integrate data from a plurality of gaming-related data sources, taking an inference drawn from analysis of data collected by a data sources, applying a data integration rule matrix to determine the extent to which to apply the inference, and updating a data set based on the application of the rule.

A data integration facility is used in association with a system, such as the gaming platform, to iteratively collect and make inferences about data that is collected for use in the gaming platform. Iteration may be performed a plurality of times, or continuously, as an on-going process to collect and make inferences about data attributes. Iteration may be a function of the entire data set (e.g., an entire content usage history of a user), or a function of specific data segments (e.g., content usage history<24 hours). Data attributes may be stored for subsequent comparison to previously collected data inference attributes. In embodiments, this process may be continuous, and represent an ongoing comparison of inferred attributes for the purpose of detecting differences over time.

The data integration facility may include at least one of a bridge, a message broker, a queue and a connector. Therefore, a useful data source may be associated with a data integration facility via computer code, hardware, or both, that establishes a connection between the source and the data integration facility. For example, the bridge may include code that takes data in a native data type (such as data in a mark-up language format), extracts the relevant portion of the data, and transforms the data into a different format, such as a format suitable for storing the data for use in the gaming platform, or by users of the gaming platform. The message broker may extract data from a data source (e.g., a client's website), place the data in a queue or storage location for delivery to a target location (e.g., gaming platform server), and deliver the data at an appropriate time and in an appropriate format for the target location (e.g., to a user of the gaming platform). In embodiments, the target location is a gaming platform database, a data mart, a metadata facility, or a facility for storing or associating an attribute within the gaming platform. The connector may comprise an application programming interface or other code suitable to connect source and target data facilities, with or without an intermediate facility such as a data mart or a data bag. The connector may, for example, include AJAX code, a SOAP connector, a Java connector, a WSDL connector, or the like.

In embodiments, the data integration facility is used to integrate data from a plurality of gaming-related data sources, the data sources including attributes relevant to the gaming platform. The data integration facility may include a syndication facility. The syndication facility may publish information in a suitable format for further use by computing devices, services, or the like, such as in aid of creating, updating or maintaining a monetization platform database, such as one related to user behavioral profiles, publishers, or some other type of data used by the gaming platform, as described herein. For example, the syndication facility may publish relevant data in RSS, XML, OPML or similar format, such as user data, wireless operator data, ad conversion data, publisher data, and many other types of information that are used by the gaming platform. The syndication facility may be configured by the data integration facility to feed data directly to a gaming platform database, such as a user profile database, in order to populate relevant fields of the database with data, to populate attributes of the database, to populate metadata in the database, or the like. In embodiments the syndicated data is used in conjunction with a rules engine, such as to assist in various inferencing processes, to assist in confirming other data, or the like.

In embodiments, the data integration facility may include a services oriented architecture facility. In the services oriented architecture facility, one or more data integration steps are deployed as a service that is accessible to various computing devices and services, including services that assist in the development, updating and maintenance of a gaming platform database, such as a user profile database, or the like. Services may include services to assist with inferences, such as by implementing rules, hierarchies of rules, or the like, such as to assist in confirmation of data from various sources. Services may be published in a registry with information about how to access the services, so that various data integration facilities may use the services. Access may be APIs, connectors, or the like, such as using Web Services Definition Language, enterprise Java beans, or various other codes suitable for managing data integration in a services oriented architecture.

In embodiments, the data integration facility may include at least one of a spidering facility, a web crawler, a clustering facility, a scraping facility and a filtering facility. The spidering facility, or other similar facility may thus search for data, such as available from various domains, services, gaming platform sources, publishers, and sources, available on the Internet or other networks, extract the data (such as by scraping or clustering data that appears to be of a suitable type), filter the data based on various filters, and deliver the data, such as to a gaming platform database. Thus, by spidering relevant data sources, the data integration facility may find relevant data, such as user behavioral data, contextual data relating to content, publisher data, and many other types (of the types variously described herein) of information. The relevant data may be used to draw inferences, to support inferences, to contradict inferences, or the like, with the inference engine, such as to assist in creation, maintenance or updating of a gaming platform database. The data may also be used to populate data fields directly, to populate attributes associated with data items, or provide metadata.

The methods and systems described herein may be deployed in part or in whole through a machine that executes computer software, program codes, and/or instructions on a processor. The processor may be part of a server, client, network infrastructure, mobile computing platform, stationary computing platform, or other computing platform. A processor may be any kind of computational or processing device capable of executing program instructions, codes, binary instructions and the like. The processor may be or may include a signal processor, digital processor, embedded processor, microprocessor or any variant such as a co-processor (math co-processor, graphic co-processor, communication co-processor and the like) and the like that may directly or indirectly facilitate execution of program code or program instructions stored thereon. In addition, the processor may enable execution of multiple programs, threads, and codes. The threads may be executed simultaneously to enhance the performance of the processor and to facilitate simultaneous operations of the application. By way of implementation, methods, program codes, program instructions and the like described herein may be implemented in one or more thread. The thread may spawn other threads that may have assigned priorities associated with them; the processor may execute these threads based on priority or any other order based on instructions provided in the program code. The processor may include memory that stores methods, codes, instructions and programs as described herein and elsewhere. The processor may access a storage medium through an interface that may store methods, codes, and instructions as described herein and elsewhere. The storage medium associated with the processor for storing methods, programs, codes, program instructions or other type of instructions capable of being executed by the computing or processing device may include but may not be limited to one or more of a CD-ROM, DVD, memory, hard disk, flash drive, RAM, ROM, cache and the like.

A processor may include one or more cores that may enhance speed and performance of a multiprocessor. In embodiments, the process may be a dual core processor, quad core processors, other chip-level multiprocessor and the like that combine two or more independent cores (called a die).

The methods and systems described herein may be deployed in part or in whole through a machine that executes computer software on a server, client, firewall, gateway, hub, router, or other such computer and/or networking hardware. The software program may be associated with a server that may include a file server, print server, domain server, internet server, intranet server and other variants such as secondary server, host server, distributed server and the like. The server may include one or more of memories, processors, computer readable media, storage media, ports (physical and virtual), communication devices, and interfaces capable of accessing other servers, clients, machines, and devices through a wired or a wireless medium, and the like. The methods, programs or codes as described herein and elsewhere may be executed by the server. In addition, other devices required for execution of methods as described in this application may be considered as a part of the infrastructure associated with the server.

The server may provide an interface to other devices including, without limitation, clients, other servers, printers, database servers, print servers, file servers, communication servers, distributed servers and the like. Additionally, this coupling and/or connection may facilitate remote execution of program across the network. The networking of some or all of these devices may facilitate parallel processing of a program or method at one or more location without deviating from the scope of the disclosure. In addition, any of the devices attached to the server through an interface may include at least one storage medium capable of storing methods, programs, code and/or instructions. A central repository may provide program instructions to be executed on different devices. In this implementation, the remote repository may act as a storage medium for program code, instructions, and programs.

The software program may be associated with a client that may include a file client, print client, domain client, internet client, intranet client and other variants such as secondary client, host client, distributed client and the like. The client may include one or more of memories, processors, computer readable media, storage media, ports (physical and virtual), communication devices, and interfaces capable of accessing other clients, servers, machines, and devices through a wired or a wireless medium, and the like. The methods, programs or codes as described herein and elsewhere may be executed by the client. In addition, other devices required for execution of methods as described in this application may be considered as a part of the infrastructure associated with the client.

The client may provide an interface to other devices including, without limitation, servers, other clients, printers, database servers, print servers, file servers, communication servers, distributed servers and the like. Additionally, this coupling and/or connection may facilitate remote execution of program across the network. The networking of some or all of these devices may facilitate parallel processing of a program or method at one or more location without deviating from the scope of the disclosure. In addition, any of the devices attached to the client through an interface may include at least one storage medium capable of storing methods, programs, applications, code and/or instructions. A central repository may provide program instructions to be executed on different devices. In this implementation, the remote repository may act as a storage medium for program code, instructions, and programs.

The methods and systems described herein may be deployed in part or in whole through network infrastructures. The network infrastructure may include elements such as computing devices, servers, routers, hubs, firewalls, clients, personal computers, communication devices, routing devices and other active and passive devices, modules and/or components as known in the art. The computing and/or non-computing device(s) associated with the network infrastructure may include, apart from other components, a storage medium such as flash memory, buffer, stack, RAM, ROM and the like. The processes, methods, program codes, instructions described herein and elsewhere may be executed by one or more of the network infrastructural elements.

The methods, program codes, and instructions described herein and elsewhere may be implemented on a cellular network having multiple cells. The cellular network may either be frequency division multiple access (FDMA) network or code division multiple access (CDMA) network. The cellular network may include mobile devices, cell sites, base stations, repeaters, antennas, towers, and the like. The cell network may be a GSM, GPRS, 3G, EVDO, mesh, or other networks types.

The methods, programs codes, and instructions described herein and elsewhere may be implemented on or through mobile devices. The mobile devices may include navigation devices, cell phones, mobile phones, mobile personal digital assistants, laptops, palmtops, netbooks, pagers, electronic books readers, music players and the like. These devices may include, apart from other components, a storage medium such as a flash memory, buffer, RAM, ROM and one or more computing devices. The computing devices associated with mobile devices may be enabled to execute program codes, methods, and instructions stored thereon. Alternatively, the mobile devices may be configured to execute instructions in collaboration with other devices. The mobile devices may communicate with base stations interfaced with servers and configured to execute program codes. The mobile devices may communicate on a peer-to-peer network, mesh network, or other communications network. The program code may be stored on the storage medium associated with the server and executed by a computing device embedded within the server. The base station may include a computing device and a storage medium. The storage device may store program codes and instructions executed by the computing devices associated with the base station.

The computer software, program codes, and/or instructions may be stored and/or accessed on machine readable media that may include: computer components, devices, and recording media that retain digital data used for computing for some interval of time; semiconductor storage known as random access memory (RAM); mass storage typically for more permanent storage, such as optical discs, forms of magnetic storage like hard disks, tapes, drums, cards and other types; processor registers, cache memory, volatile memory, non-volatile memory; optical storage such as CD, DVD; removable media such as flash memory (e.g. USB sticks or keys), floppy disks, magnetic tape, paper tape, punch cards, standalone RAM disks, Zip drives, removable mass storage, off-line, and the like; other computer memory such as dynamic memory, static memory, read/write storage, mutable storage, read only, random access, sequential access, location addressable, file addressable, content addressable, network attached storage, storage area network, bar codes, magnetic ink, and the like.

The methods and systems described herein may transform physical and/or or intangible items from one state to another. The methods and systems described herein may also transform data representing physical and/or intangible items from one state to another.

The elements described and depicted herein, including in flow charts and block diagrams throughout the figures, imply logical boundaries between the elements. However, according to software or hardware engineering practices, the depicted elements and the functions thereof may be implemented on machines through computer executable media having a processor capable of executing program instructions stored thereon as a monolithic software structure, as standalone software modules, or as modules that employ external routines, code, services, and so forth, or any combination of these, and all such implementations may be within the scope of the present disclosure. Examples of such machines may include, but may not be limited to, personal digital assistants, laptops, personal computers, mobile phones, other handheld computing devices, medical equipment, wired or wireless communication devices, transducers, chips, calculators, satellites, tablet PCs, electronic books, gadgets, electronic devices, devices having artificial intelligence, computing devices, networking equipments, servers, routers and the like. Furthermore, the elements depicted in the flow chart and block diagrams or any other logical component may be implemented on a machine capable of executing program instructions. Thus, while the foregoing drawings and descriptions set forth functional aspects of the disclosed systems, no particular arrangement of software for implementing these functional aspects should be inferred from these descriptions unless explicitly stated or otherwise clear from the context. Similarly, it will be appreciated that the various steps identified and described above may be varied, and that the order of steps may be adapted to particular applications of the techniques disclosed herein. All such variations and modifications are intended to fall within the scope of this disclosure. As such, the depiction and/or description of an order for various steps should not be understood to require a particular order of execution for those steps, unless required by a particular application, or explicitly stated or otherwise clear from the context.

The methods and/or processes described above, and steps thereof, may be realized in hardware, software or any combination of hardware and software suitable for a particular application. The hardware may include a general purpose computer and/or dedicated computing device or specific computing device or particular aspect or component of a specific computing device. The processes may be realized in one or more microprocessors, microcontrollers, embedded microcontrollers, programmable digital signal processors or other programmable device, along with internal and/or external memory. The processes may also, or instead, be embodied in an application specific integrated circuit, a programmable gate array, programmable array logic, or any other device or combination of devices that may be configured to process electronic signals. It will further be appreciated that one or more of the processes may be realized as a computer executable code capable of being executed on a machine readable medium.

The computer executable code may be created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software, or any other machine capable of executing program instructions.

Thus, in one aspect, each method described above and combinations thereof may be embodied in computer executable code that, when executing on one or more computing devices, performs the steps thereof. In another aspect, the methods may be embodied in systems that perform the steps thereof, and may be distributed across devices in a number of ways, or all of the functionality may be integrated into a dedicated, standalone device or other hardware. In another aspect, the means for performing the steps associated with the processes described above may include any of the hardware and/or software described above. All such permutations and combinations are intended to fall within the scope of the present disclosure.

While the disclosure has been disclosed in connection with the preferred embodiments shown and described in detail, various modifications and improvements thereon will become readily apparent to those skilled in the art. Accordingly, the spirit and scope of the present disclosure is not to be limited by the foregoing examples, but is to be understood in the broadest sense allowable by law.

All documents referenced herein are hereby incorporated by reference.

What is claimed is:

1. A method for providing a computerized game, comprising:
preparing questions on an educational topic related to improving the health of one or more individuals;
arranging the questions using at least one computer;
preparing answers for the questions; and
scoring by the at least one computer answers for the questions for one or more players, wherein the questions and the answers form game elements that are adapted for use in at least two different games of at least two different formats without requiring a game developer to modify source code of the game elements.

2. The method of claim 1, wherein the game formats are selected from the group consisting of: a quiz game; a quiz game in which scoring is measured by a higher or lower score; a board game; a board game in which scoring is measured by progress toward a goal; and a board game in which scoring is measured by acquiring desired objects.

3. The method of claim 1, wherein at least one of the computerized game elements is stored remotely to be accessed as a software service, wherein the one or more individuals play the computerized game through a user graphical interface downloadable to computers of the one or more individuals.

4. The method of claim 1, wherein the topics are selected from the group consisting of a disease, a disease management technique, nutrition, nutrition management, health management, health, exercise, exercise management, medical science, anatomy and physiology.

5. The method of claim 1, further comprising reporting a score for the one or more individuals and posting scores on a leaderboard that ranks the individuals by scoring.

6. The method of claim 1, wherein the one or more individuals playing the game comprise an interest group related by a topic of the game.

7. The method of claim 1, further comprising gathering information on the one or more individuals and using the information to educate the one or more individuals on the educational topic.

8. The method of claim 1, wherein a plurality of questions concern progress by at least one individual toward a health, wellness or educational goal.

9. The method of claim 1, further comprising linking by the at least one computer an identity of the one or more individuals on a site for the computerized game to an identity of the one or more individuals on another electronic or internet site.

10. The method of claim 9 wherein the site is selected from the group consisting of: a social networking site; an e-mail address; a cellphone or telephone number; and a user ID for an internet site.

11. The method of claim 1, further comprising storing scores from the computerized game for the one or more individuals.

12. A system for a computerized game stored on a non-transitory, machine readable medium, the system comprising:
an application database accessible to at least one computer, the application database comprising information, questions and answers on a plurality of topics on health and health management topics;
a gaming engine stored on a memory of the system, the gaming engine comprising a plurality of game elements comprising questions and answers for the plurality of topics on health and health management, wherein each game element has formats for at least two different games of at least two different formats and wherein each game element is adapted for inclusion in such different games without requiring the editing of source code;
a gaming portal for monitoring aspects of the gaming engine and the application database;
an interface for a plurality of players for the game, the interface allowing the plurality of players access to the gaming engine and the application database; and
a graphical user interface accessible to the plurality of players for the game, the graphical user interface downloadable onto local computers for the one or more players.

13. The computer system of claim 12, wherein the computerized game is available as software as a service for the plurality of players for the game, with only the graphical user interface downloadable onto local computers for the one or more players.

14. The computer system of claim 12, wherein the formats are selected from the group consisting of: a quiz game; a quiz game in which scoring is measured by a higher or lower score; a board game; a board game in which scoring is measured by progress toward a goal; and a board game in which scoring is measured by acquiring desired objects.

15. The computer system of claim 12, wherein the gaming engine allows a plurality of players to play at least one game, and wherein the gaming engine allows each of the plurality of players to see progress or scoring of other players in the at least one game.

16. The computer system of claim 15, wherein the gaming engine allows the plurality of players to play the at least one game sequentially or simultaneously.
